(19) United States
(12) Patent Application Publication
(10) Pub. No.: US 2024/0303558 A1
(43) Pub. Date: Sep. 12, 2024

(54) TRAVEL PLAN GENERATING APPARATUS, TRAVEL PLAN GENERATING METHOD AND PROGRAM

(71) Applicant: NIPPON TELEGRAPH AND TELEPHONE CORPORATION, Tokyo (JP)

(72) Inventors: Kazuaki AKASHI, Musashino-shi, Tokyo (JP); Shunsuke KANAI, Musashino-shi, Tokyo (JP); Manami OGAWA, Musashino-shi, Tokyo (JP); Yusuke NAKANO, Musashino-shi, Tokyo (JP); Zhao WANG, Musashino-shi, Tokyo (JP)

(73) Assignee: NIPPON TELEGRAPH AND TELEPHONE CORPORATION, Tokyo (JP)

(21) Appl. No.: 18/278,631

(22) PCT Filed: Mar. 9, 2021
(86) PCT No.: PCT/JP2021/009339

§ 371 Date: Aug. 24, 2023

(51) Int. Cl. G06Q 10/047

(52) U.S. Cl. CPC G06Q 10/047

(57) ABSTRACT

A travel plan generation device according to an aspect of the present invention is provided with a generation unit that generates a travel plan for traveling a plurality of points by a plurality of mobile bodies by performing, at each output step, processing of selecting any one point out of the plurality of points by using a recurrent neural network configured to output visiting probabilities at the plurality of points when point information regarding the plurality of points and mobile body information regarding the plurality of mobile bodies are input, and mask information indicating an unselectable point out of the plurality of points, and an output unit that outputs the travel plan, in which points already selected for the plurality of mobile bodies excluding a point previously selected for each mobile body are set as unselectable points in the mask information of the each mobile body.

### TECHNICAL FIELD

The present invention relates to combination optimization such as a vehicle routing problem (VRP).

### BACKGROUND ART

The vehicle routing problem is a problem of acquiring an optimal travel plan under various constraint conditions (such as the number of vehicles, a loading capacity of the vehicle, for example) when delivering or picking up packages such as packages of a home delivery service or backup resources to a disaster-stricken area to and from a large number of points. The travel plan includes a route for each vehicle. The optimal travel plan refers to, for example, a travel plan in which the sum of travel distances is the shortest.

Since the number of patterns (combinations) of the routes is enormous, it is difficult to acquire a strictly optimal travel plan. Therefore, an approach of acquiring a travel plan close to the optimal one in a short time by utilizing machine learning is taken.

In the approach of solving the vehicle routing problem by utilizing machine learning, a method of using a recurrent neural network (RNN) to which an attention mechanism is introduced is known. Non Patent Literatures 1 and 2 disclose a method of acquiring a travel plan in a case where there is one vehicle. Non Patent Literature 3 discloses a method of acquiring a travel plan under a rule that a vehicle selects visiting points in predetermined order in a case where there is a plurality of vehicles. In Non Patent Literature 3, due to the above-described rule, the travel plan that may be output is restricted. Therefore, depending on a problem case, a travel plan that is not optimal might be acquired.

### CITATION LIST

### Non Patent Literature

Non Patent Literature 1: Irwan Bello, Hieu Pham, Quoc V. Le, Mohammad Norouzi, and Samy Bengio, “Neural Combinatorial Optimization with Reinforcement Learning,” arXiv preprint, arXiv: 1611.09940, 2016.
Non Patent Literature 2: Mohammadreza Nazari, Afshin Oroojlooy, Martin Takac, and Lawrence V. Snyder, “Reinforcement Learning for Solving the Vehicle Routing Problem,” 32nd Conference on Neural Information Processing Systems (2018).
Non Patent Literature 3: Jose Manuel Vera and Andres G. Abad, “Deep Reinforcement Learning for Routing a Heterogeneous Fleet of Vehicles,” IEEE LA-CCI, 2019.

### SUMMARY OF INVENTION

### Technical Problem

An object of the present invention is to provide a technology capable of acquiring a travel plan close to an optimal plan.

### Solution to Problem

A travel plan generation device according to an aspect of the present invention is provided with a generation unit that generates a travel plan for traveling a plurality of points by a plurality of mobile bodies by performing, at each output step, processing of selecting any one point out of the plurality of points by using a recurrent neural network configured to output visiting probabilities at the plurality of points when point information regarding the plurality of points and mobile body information regarding the plurality of mobile bodies are input, and mask information indicating an unselectable point out of the plurality of points, and an output unit that outputs the travel plan, in which points already selected for the plurality of mobile bodies excluding a point previously selected for each mobile body are set as unselectable points in the mask information of the each mobile body.

### Advantageous Effects of Invention

The present invention provides a technology capable of acquiring a travel plan close to an optimal plan.

### BRIEF DESCRIPTION OF DRAWINGS

FIG. 1 is a block diagram illustrating a travel plan generation device according to an embodiment of the present invention.

FIG. 2 is a diagram illustrating an RNN used by a travel plan generation unit illustrated in FIG. 1.

FIG. 3 is a diagram illustrating a specific example of the RNN used by the travel plan generation unit illustrated in FIG. 1.

FIG. 4 is a diagram illustrating a problem case handled by the travel plan generation device in FIG. 1.

FIG. 5 is a block diagram illustrating a hardware configuration of the travel plan generation device in FIG. 1.

FIG. 6 is a block diagram illustrating a learning device according to an embodiment of the present invention.

FIG. 7 is a flowchart illustrating an operation of the travel plan generation device in FIG. 1.

FIG. 8 is a flowchart illustrating an operation of the travel plan generation device in FIG. 1.

FIG. 9 is a diagram illustrating an operation of the travel plan generation device in FIG. 1.

FIG. 10 is a diagram for explaining travel plan generation processing in the travel plan generation device in FIG. 1.

FIG. 11 is a diagram for explaining travel plan generation processing in the conventional art.

### DESCRIPTION OF EMBODIMENTS

Hereinafter, an embodiment of the present invention is described with reference to the drawings.

### [Configuration]

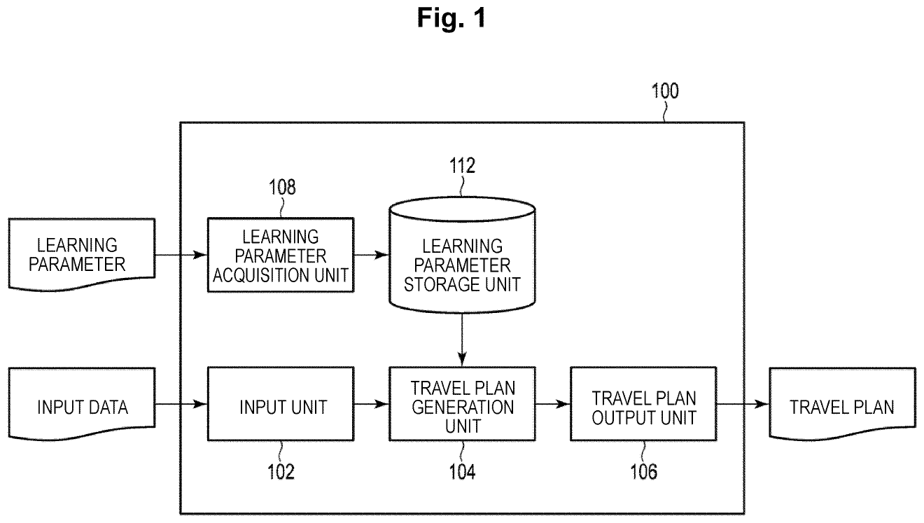

FIG. 1 schematically illustrates a travel plan generation device 100 according to an embodiment of the present invention. The travel plan generation device 100 illustrated in FIG. 1 generates a travel plan for traveling a plurality of points by a plurality of vehicles. For example, the travel plan generation device 100 determines routes of the plurality of vehicles in order to deliver packages to the plurality of points by the plurality of vehicles. A purpose of the vehicles to visit the points is not limited to package delivery. For example, the purpose may be package pickup. The purpose may be an action not involving package exchange. The travel plan includes a route for each vehicle. The route of each vehicle indicates points visited by the vehicle and order thereof.

In the example illustrated in FIG. 1, the travel plan generation device 100 is provided with an input unit 102, a travel plan generation unit 104, a travel plan output unit 106, a learning parameter acquisition unit 108, and a learning parameter storage unit 112.

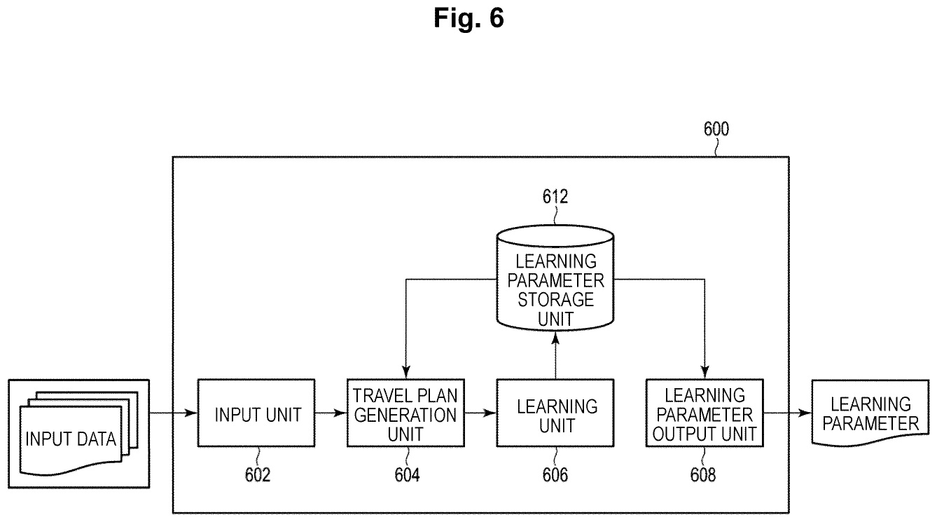

The learning parameter acquisition unit 108 acquires a learning parameter determined by a learning device 600 to be described later (FIG. 6) and stores the learning parameter in the learning parameter storage unit 112. In an example in which the travel plan generation device 100 is connected to the learning device 600 via a network, the learning parameter acquisition unit 108 receives the learning parameter from the learning device 600 via the network. The learning parameter includes a weight applied to a neural network used by the travel plan generation unit 104.

The input unit 102 acquires point information regarding the plurality of points and vehicle information regarding the plurality of vehicles as input data. In an example in which the travel plan generation device 100 is connected to a terminal device used by a human operator via the network, the input unit 102 receives the input data from the terminal device via the network. Alternatively, the input unit 102 may receive the input data from an input device (for example, a keyboard) connected to the travel plan generation device 100. The input data includes information indicating a problem case for which the travel plan is generated. The point information includes information indicating positions and package request amounts (for example, amounts of packages to be delivered) of the plurality of points. The vehicle information includes information indicating positions and loading capacities (for example, amounts of loadable packages) of the plurality of vehicles.

The travel plan generation unit 104 generates the travel plan on the basis of the vehicle information and the point information acquired by the input unit 102. In order to generate the travel plan, the travel plan generation unit 104 may use a recurrent neural network (RNN) provided with an attention mechanism trained in advance. The travel plan generation unit 104 acquires the learning parameter from the learning parameter storage unit 112 and applies the learning parameter to the RNN.

The RNN is configured to output visiting probabilities at the plurality of points when the point information and the vehicle information are input thereto. The visiting probability at each point is a probability that the vehicle will come to deliver the package under a certain situation of the point, and indicates likelihood that the point will be visited under a certain situation. The travel plan generation unit 104 holds mask information indicating an unselectable point out of the plurality of points for each vehicle. The travel plan generation unit 104 performs, at each output step, processing of selecting any one point out of the plurality of points using the RNN and the mask information, and acquires the travel plan as a result. The processing includes selecting one of the plurality of vehicles in predetermined order. Hereinafter, the vehicle selected at each output step is also referred to as a target vehicle. The output step is also referred to as a time step.

The travel plan output unit 106 outputs the travel plan generated by the travel plan generation unit 104. For example, the travel plan output unit 106 transmits the travel plan to the terminal device described above via the network. Alternatively, the travel plan output unit 106 may display the travel plan on a display device connected to the travel plan generation device 100.

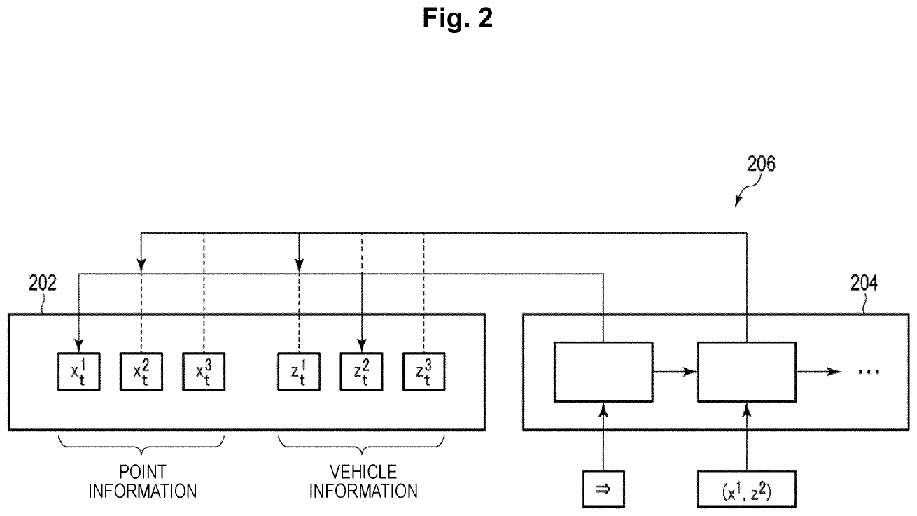

FIG. 2 schematically illustrates an example of the RNN used by the travel plan generation unit 104. In the example illustrated in FIG. 2, the RNN is provided with an encoder 202 and a decoder 204 as RNN modules, and an attention mechanism 206.

The travel plan generation unit 104 inputs the point information and the vehicle information to the encoder 202. The encoder 202 embeds the point information and the vehicle information in a space of a fixed number of dimensions. Specifically, the encoder 202 generates an embedded vector of a fixed number of dimensions corresponding to the point information, and generates an embedded vector of a fixed number of dimensions corresponding to the vehicle information. Hereinafter, the embedded vector corresponding to the point information is also referred to as a point information vector, and the embedded vector corresponding to the vehicle information is also referred to as a vehicle information vector. The encoder 202 provides the point information vector and the vehicle information vector to the attention mechanism 206.

The decoder 204 receives information regarding a point selected at a previous output step from the travel plan generation unit 104, and generates a hidden vector on the basis of the received information. The decoder 204 holds the hidden vector generated at the previous output step, and uses the held hidden vector to generate a new hidden vector. Specifically, the decoder 204 generates the hidden vector at a current output step on the basis of the information regarding the point selected at the previous output step and the hidden vector generated by itself at the previous output step. The decoder 204 provides the generated hidden vector to the attention mechanism 206.

The attention mechanism 206 calculates the visiting probability at the point on the basis of the point information vector and the vehicle information vector received from the encoder 202 and the hidden vector received from the decoder 204.

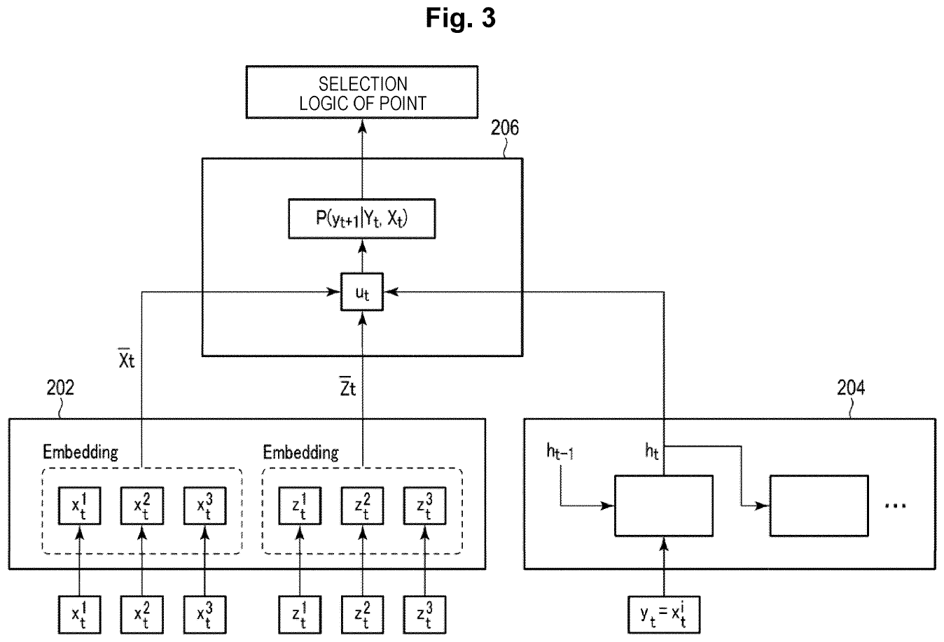

FIG. 3 schematically illustrates a specific example of the RNN illustrated in FIG. 2. In FIG. 3, Xₜ represents a vector indicating the point information at an output step t. The vector Xₜ may be expressed as follows.

$${X}_{t} = ( {x}_{t}^{1} , {x}_{t}^{2} , … , {x}_{t}^{N} ) \qquad [ Math . 1 ]$$

Herein, N represents the number of points. An i-th element xⁱₜ of the vector Xₜ indicates the point information at a point i. Any integer from 1 to N is represented by i.

Zₜ represents a vector indicating the vehicle information at the output step t. The vector Zₜ may be expressed as follows.

$${Z}_{t} = ( {z}_{t}^{1} , {z}_{t}^{2} , … , {z}_{t}^{M} ) \qquad [ Math . 2 ]$$

Herein, M represents the number of vehicles. A j-th element z^{j}ₜ of the vector Zₜ indicates the vehicle information of a vehicle j. Any integer from 1 to M is represented by j.

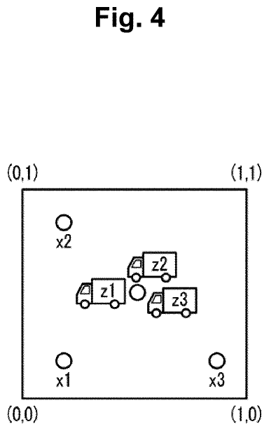

FIG. 4 schematically illustrates an example of the problem case handled by the travel plan generation device 100. Specifically, FIG. 4 illustrates the problem case in which vehicles z1, z2, and z3 each with a loading capacity of “ten” are present at a departure point at coordinates (0.5, 0.5), packages of a requested amount of “eight” are delivered to a point x1 at coordinates (0.1, 0.1), packages of a requested amount of “three” are delivered to a point x2 at coordinates (0.1, 0.9), and packages of a requested amount of “5” are delivered to a point x3 at coordinates (0.9, 0.1). In this case, a vector X₀ and a vector Z₀ corresponding to the point information and the vehicle information acquired by the input unit 102, respectively, are expressed as follows.

$${X}_{0} = ( ( 0.1 , 0.1 , 8 ) , ( 0.1 , 0.9 , 3 ) , ( 0.9 , 0.1 , 5 ) ) \qquad [ Math . 3 ]$$

$${Z}_{0} = ( ( 0.5 , 0.5 , 10 ) , ( 0.5 , 0.5 , 10 ) , ( 0.5 , 0.5 , 10 ) )$$

Referring back to FIG. 3, yₜ=xⁱₜ indicates information regarding the point selected at the output step t. Yₜ represents a vector indicating the information regarding the point selected at output steps 0 to t. The vector Yₜ may be expressed as follows.

$${Y}_{t} = ( {y}_{0} , {y}_{1} , … , {y}_{t} ) \qquad [ Math . 4 ]$$

The attention mechanism 206 receives the point information vector and the vehicle information vector from the encoder 202. The point information vector is the embedded vector generated from the vector Xₜ, and the vehicle information vector is the embedded vector generated from the vector Zₜ.

### [Math. 5]

Point information vector is represented by X̅ₜ, and vehicle information vector is represented by Z̅ₜ.

The attention mechanism 206 further receives a hidden vector hₜ from the decoder 204. The attention mechanism 206 calculates the visiting probabilities at the plurality of points on the basis of the point information vector, the vehicle information vector, and the hidden vector hₜ.

The attention mechanism 206 generates an attention vector uₜ on the basis of the point information vector, the vehicle information vector, and the hidden vector hₜ. The attention vector uₜ may be expressed as follows.

$${u}_{t} = {v}^{T} tanh ( W [ {\overline{X}}_{t} ; {\overline{Z}}_{t} ; {h}_{t} ] ) \qquad [ Math . 6 ]$$

Herein, a superscript T indicates transposition of a matrix. An operator “;” indicates concatenation. For example, A;B means concatenating a vector A with a vector B. The learning parameters are represented by v and W.

The attention mechanism 206 calculates a visiting probability P (Yₜ₊₁|Yₜ, Xₜ) at the plurality of points on the basis of the attention vector uₜ. The visiting probability P (yₜ₊₁|Yₜ, Xₜ) may be expressed as follows.

$$P ( {y}_{t + 1} \vert {Y}_{t} , {X}_{t} ) = softmax ( {u}_{t} ) \qquad [ Math . 7 ]$$

Herein, Yₜ₊₁ indicates a point selected at an output step t+1.

The travel plan generation unit 104 selects one of the points excluding the point indicated as the unselectable point in the mask information of the target vehicle on the basis of the visiting probability at the point output from the RNN. For example, the travel plan generation unit 104 changes the visiting probability at the point indicated as the unselectable point in the mask information of the target vehicle to zero, and then selects a point of the largest visiting probability. The travel plan generation unit 104 adds the selected point to the route of the target vehicle.

The travel plan generation unit 104 updates the mask information on the basis of the selected point. In a case where the point newly selected for the target vehicle is different from the point previously selected for the target vehicle, the travel plan generation unit 104 adds the point previously selected for the target vehicle to the mask information of the target vehicle as the unselectable point. In a case where the point newly selected for the target vehicle is different from the point previously selected for the target vehicle, the travel plan generation unit 104 adds the point newly selected for the target vehicle to the mask information of the vehicles excluding the target vehicle as the unselectable point. In a case where the point newly selected for the target vehicle is the same as the point previously selected for the target vehicle, and the points newly selected for the plurality of vehicles excluding the target vehicle are the same as the points previously selected for the plurality of vehicles excluding the target vehicle, the travel plan generation unit 104 adds the point previously selected for each vehicle to the mask information of each vehicle as the unselectable point.

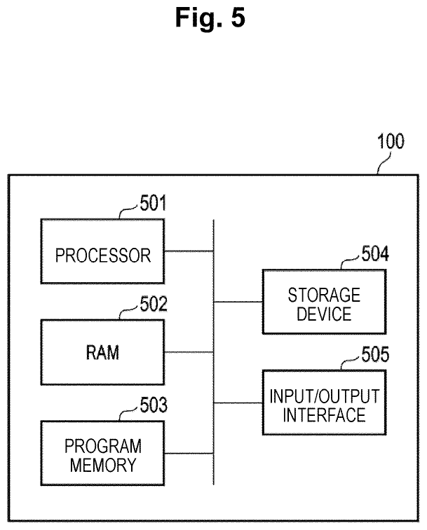

FIG. 5 schematically illustrates a hardware configuration example of the travel plan generation device 100. In the example illustrated in FIG. 5, the travel plan generation device 100 is provided with a processor 501, a random access memory (RAM) 502, a program memory 503, a storage device 504, and an input/output interface 505. The processor 501 controls the RAM 502, the program memory 503, the storage device 504, and the input/output interface 505 and exchanges signals with them.

The processor 501 includes a general-purpose circuit such as a central processing unit (CPU) or a graphics processing unit (GPU). The RAM 502 is used by the processor 501 as a working memory. For example, the RAM 502 is used for holding the mask information. The RAM 502 includes a volatile memory such as an SDRAM. The program memory 503 stores programs executed by the processor 501, the programs including a travel plan generation program. The program includes a computer-executable instruction. For example, a ROM is used as the program memory 503. A partial area of the storage device 504 may be used as the program memory 503.

The processor 501 expands the program stored in the program memory 503 on the RAM 502 to interpret and execute the program. When executed by the processor 501, the travel plan generation program causes the processor 501 to perform a series of processing including the processing described regarding the travel plan generation unit 104 of the travel plan generation device 100.

The program may be provided to the travel plan generation device 100 in a state of being stored in a computer-readable recording medium. In this case, the travel plan generation device 100 is provided with a drive that reads data from the recording medium and acquires the program from the recording medium. Examples of the recording medium include a magnetic disk, an optical disk (such as CD-ROM, CD-R, DVD-ROM, and DVD-R), a magneto-optical disk (such as MO), and a semiconductor memory. The program may be distributed via a network. Specifically, the program may be stored in a server on the network, and the travel plan generation device 100 may download the program from the server.

The storage device 504 stores data such as the learning parameter. The storage device 504 includes a nonvolatile memory such as a hard disk drive (HDD) or a solid state drive (SSD).

The input/output interface 505 is provided with a communication module for communicating with an external device and a plurality of terminals for connecting peripheral devices. The communication module includes a wired module and/or a wireless module. Examples of the peripheral device include a display device, a keyboard, and a mouse. The processor 501 acquires the data such as the point information, the vehicle information, and the learning parameter via the input/output interface 505. The processor 501 outputs the travel plan via the input/output interface 505.

FIG. 6 schematically illustrates the learning device 600 according to an embodiment of the present invention. The learning device 600 illustrated in FIG. 6 trains the learning parameter of a neural network used by the travel plan generation device 100 illustrated in FIG. 1. The learning device 600 optimizes the learning parameter using results of a large number of times of simulations and the like.

As illustrated in FIG. 6, the learning device 600 is provided with an input unit 602, a travel plan generation unit 604, a learning unit 606, a learning parameter output unit 608, and a learning parameter storage unit 612. The learning device 600 may be implemented by causing a processor to execute a program. The learning device 600 may have a hardware configuration similar to that illustrated in FIG. 5.

The input unit 602 acquires a large number of learning data sets. The learning data set is prepared by, for example, random creation and the like. Each learning data set includes the point information and the vehicle information.

The travel plan generation unit 604 generates the travel plan on the basis of each learning data set. The travel plan generation unit 604 generates the travel plan by the same method as that of the travel plan generation unit 104 illustrated in FIG. 1. The travel plan generation unit 604 uses an RNN having the same configuration as that of the RNN used by the travel plan generation unit 104. The travel plan generation unit 604 generates the travel plan on the basis of the learning data set using the RNN to which the learning parameter stored in the learning parameter storage unit 612 is applied. The learning parameter includes v and W described above.

The learning unit 606 updates the learning parameter on the basis of the travel plan generated by the travel plan generation unit 604. As a learning algorithm, for example, an advantage actor critic (A2C) algorithm may be used.

The learning device 600 repeatedly performs processing including generation of the travel plan and updating of the learning parameter. The learning parameter output unit 608 outputs a finally acquired learning parameter. For example, the learning parameter output unit 608 transmits the learning parameter to the travel plan generation device 100 illustrated in FIG. 1 via the network.

Note that, the learning device 600 is illustrated as a device different from the travel plan generation device 100, but the learning device 600 may be present in the travel plan generation device 100.

### [Operation]

Next, an operation of the travel plan generation device 100 is described.

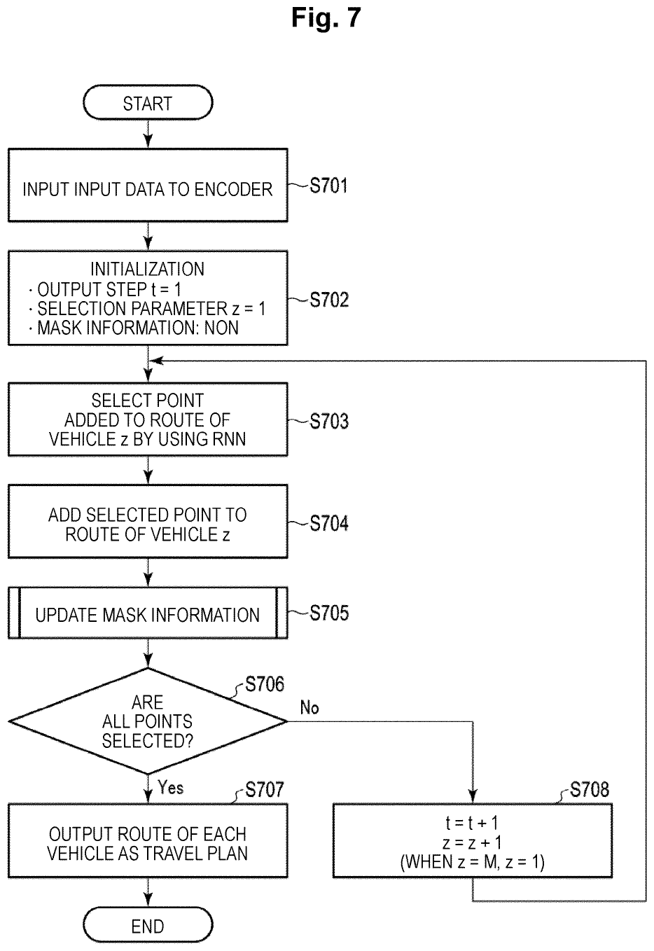

FIG. 7 schematically illustrates an operation example when the travel plan generation device 100 generates the travel plan. At step S701 in FIG. 7, the travel plan generation unit 104 receives the input data including the point information and the vehicle information from the input unit 102, and inputs the input data to the encoder 202 of the RNN. At step S702, the output step and the mask information are initialized. For example, the output step t is set to 1, a selection parameter z is set to 1, and contents of the mask information of all the vehicles are erased. The vehicle specified by the selection parameter z is referred to as the target vehicle or the vehicle z.

At step S703, the travel plan generation unit 104 selects any one of the plurality of points by using the RNN and the mask information of the target vehicle. For example, the travel plan generation unit 104 inputs the point information and the vehicle information after processing at an output step t−1 ends to the RNN, and acquires the visiting probability at the point from the RNN. The travel plan generation unit 104 sets the visiting probability at a point specified according to the mask information of the target vehicle to zero. Then, the travel plan generation unit 104 selects a point of the highest visiting probability.

At step S704, the travel plan generation unit 104 adds the selected point to the route of the target vehicle. Note that, in a case where the point newly selected for the target vehicle is the same as the point previously selected for the target vehicle, the selected point is not added to the route of the target vehicle. The travel plan generation unit 104 further generates the point information and the vehicle information at a next output step. In the problem case illustrated in FIG. 4, it is assumed that the travel plan generation unit 104 selects the point x1 and the vehicle z1. In this case, the travel plan generation unit 104 adds the point x1 to the route of the vehicle z1. The package request amount at the point x1 is “eight”, and the loading capacity of the vehicle z1 is “ten”. Therefore, the vehicle z1 may load all the packages to be delivered to the point x1. The travel plan generation unit 104 changes the package request amount at the point x1 to zero, changes the position of the vehicle z1 to coordinates (0.1, 0.1), and changes the loading capacity of the vehicle z1 to two.

At step S705, the travel plan generation unit 104 updates the mask information. Mask information updating at step S705 is described later.

At step S706, the travel plan generation unit 104 determines whether all the points are selected. In a case where any point is not selected (step S706; No), the procedure shifts to step S708. At step S708, the output step t is incremented by 1. In a case where the selection parameter z is M, the selection parameter z is set to 1; otherwise the selection parameter z is incremented by 1. The procedure returns to steps S703 and steps S703 to S705 are repeatedly executed.

In a case where all the points are selected (step S706; Yes), the procedure shifts to step S707. At step S707, the travel plan output unit 106 outputs the route of each vehicle as the travel plan.

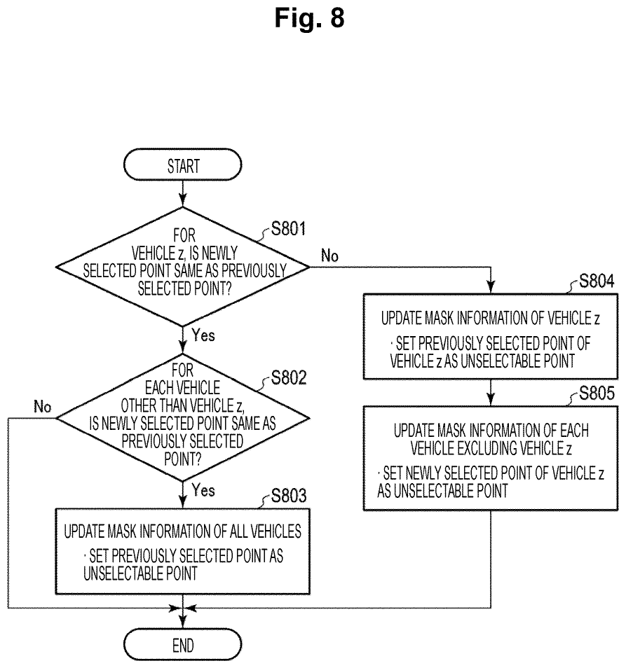

FIG. 8 schematically illustrates an operation example when the travel plan generation device 100 updates the mask information. At step S801 in FIG. 8, the travel plan generation unit 104 determines whether the point newly selected for the target vehicle is the same as the point previously selected for the target vehicle. In a case where a current output step t is t₀, the point newly selected for the target vehicle indicates the point selected at the output step t=t₀, and the point previously selected for the target vehicle indicates the point selected at an output step t=t₀−M. As described above, M represents the number of vehicles, and the target vehicle at the output step t=t₀ is the same as the target vehicle at the output step t=t₀−M.

In a case where the point newly selected for the target vehicle is different from the point previously selected for the target vehicle (step S801; No), the procedure shifts to step S804.

At step S804, the travel plan generation unit 104 updates the mask information of the target vehicle. Specifically, the travel plan generation unit 104 adds the point previously selected for the target vehicle to the mask information of the target vehicle.

At step S805, the travel plan generation unit 104 updates the mask information of other vehicles (all the vehicles excluding the target vehicle). Specifically, the travel plan generation unit 104 adds the point newly selected for the target vehicle to the mask information of the other vehicles. Then, the procedure ends.

In a case where the point newly selected for the target vehicle is the same as the point previously selected for the target vehicle (step S801; Yes), the procedure shifts to step S802. Selecting the same point as the point previously selected for the target vehicle corresponds to passing or skipping point selection for the target vehicle.

At step S802, the travel plan generation unit 104 determines whether the points newly selected for the other vehicles are the same as the points previously selected for the other vehicles. In a case where the current output step t is to, the points newly selected for the other vehicles indicate the points selected at the output steps from t₀−M+1 to t₀−1, and the points previously selected for the other vehicles indicate the points selected at the output steps from t₀−2M+1 to t₀−M−1.

In a case where the points newly selected for the other vehicles are the same as the points previously selected for the other vehicles (step S802; Yes), the procedure shifts to step S803. At step S803, the travel plan generation unit 104 updates the mask information of all the vehicles. Specifically, the travel plan generation unit 104 adds the point previously selected for each vehicle to the mask information of each vehicle. Then, the procedure ends.

The processing at step S803 is executed in a case where the same point is selected twice consecutively for each of all the vehicles. Thereby, continuous loop of the processing may be avoided.

In a case where the point newly selected for any of the other vehicles is different from the point previously selected for this vehicle (step S802; No), the travel plan generation unit 104 does not update the mask information of any vehicle, and the procedure ends.

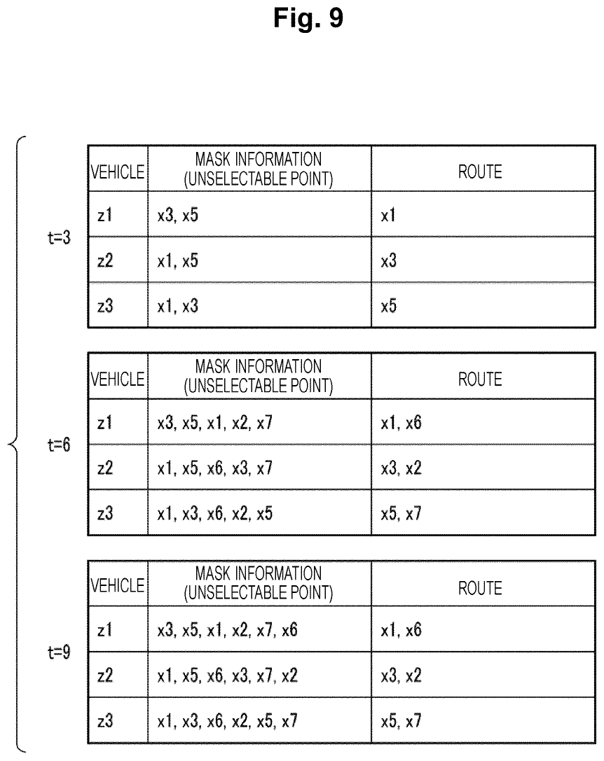

The mask information updating is specifically described with reference to FIG. 9. Herein, the problem case of generating the travel route for traveling 10 points x1 to x10 by three vehicles z1, z2, and z3 is assumed. The vehicles z1, 22, and 23 are selected in this order.

At the output step t=1, the travel plan generation unit 104 selects the vehicle z1 as the target vehicle, and selects the point x1 as the point to be added to the route of the target vehicle z1. The travel plan generation unit 104 adds the point x1 to the mask information of the vehicles z2 and z3.

At the output step t=2, the travel plan generation unit 104 selects the vehicle z2 as the target vehicle, and selects the point x3 as the point to be added to the route of the target vehicle z2. The travel plan generation unit 104 adds the point x3 to the mask information of the vehicles z1 and z3.

At the output step t=3, the travel plan generation unit 104 selects the vehicle z3 as the target vehicle, and selects the point x5 as the point to be added to the route of the target vehicle z3. The travel plan generation unit 104 adds the point x5 to the mask information of the vehicles z1 and z2.

The mask information and the route of each vehicle at the time when the processing at the output step t=3 ends are as illustrated in an upper part of FIG. 9. For example, the mask information of the vehicle z1 includes the points x3 and x5, and the route of the vehicle z1 includes the point x1.

At the output step t=4, the travel plan generation unit 104 selects the vehicle z1 as the target vehicle, and selects the point x6 as the point to be added to the route of the target vehicle z1. The point previously selected for the target vehicle z1 (selected at the output step t=1) is the point x1. The point x6 newly selected for the target vehicle z1 is different from the point x1 previously selected for the target vehicle z1. Therefore, the travel plan generation unit 104 adds the point x1 to the mask information of the vehicle z1, and adds the point x6 to the mask information of the vehicles z2 and z3.

At the output step t=5, the travel plan generation unit 104 selects the vehicle z2 as the target vehicle, and selects the point x2 as the point to be added to the route of the target vehicle z2. The point previously selected for the target vehicle z2 (selected at the output step t=2) is the point x3. The point x6 newly selected for the target vehicle z2 is different from the point x1 previously selected for the target vehicle z2. Therefore, the travel plan generation unit 104 adds the point x3 to the mask information of the vehicle z2, and adds the point x2 to the mask information of the vehicles z1 and z3.

At the output step t=6, the travel plan generation unit 104 selects the vehicle z3 as the target vehicle, and selects the point x7 as the point to be added to the route of the target vehicle z3. The point previously selected for the target vehicle z3 (selected at the output step t=3) is the point x5. The point x7 newly selected for the target vehicle 22 is different from the point x5 previously selected for the target vehicle z2. Therefore, the travel plan generation unit 104 adds the point x5 to the mask information of the vehicle z3, and adds the point x7 to the mask information of the vehicles z1 and z2.

The mask information and the route of each vehicle at the time when the processing at the output step t=6 ends are as illustrated in a middle part of FIG. 9. For example, the mask information of the vehicle z1 includes the points x3, x5, x1, x2, and x7, and the route of the vehicle z1 includes the points x1 and x6.

At the output step t=7, the travel plan generation unit 104 selects the vehicle z1 as the target vehicle, and selects the point x6 as the point to be added to the route of the target vehicle z1. The point previously selected for the target vehicle z1 is the point x6. The point x6 newly selected for the target vehicle z1 is the same as the point x6 previously selected for the target vehicle z1. The point x7 newly selected for the vehicle z3 (selected at the output step t=6) is different from the point x5 previously selected for the vehicle z3 (selected at the output step t=3). Therefore, at the output step t=7, the travel plan generation unit 104 does not update the mask information of any vehicle.

At the output step t=8, the travel plan generation unit 104 selects the vehicle z2 as the target vehicle, and selects the point x2 as the point to be added to the route of the target vehicle z2. The point previously selected for the target vehicle z2 is the point x2. The point x2 newly selected for the target vehicle z2 is the same as the point x2 previously selected for the target vehicle z2. The point x6 newly selected for the vehicle z1 (selected at the output step t=7) is the same as the point x6 previously selected for the vehicle z1 (selected at the output step t=4). The point x7 newly selected for the vehicle z3 (selected at the output step t=6) is different from the point x5 previously selected for the vehicle z3 (selected at the output step t=3). Therefore, at the output step t=8, the travel plan generation unit 104 does not update the mask information of any vehicle.

At the output step t=9, the travel plan generation unit 104 selects the vehicle z3 as the target vehicle, and selects the point x7 as the point to be added to the route of the target vehicle z3. The point previously selected for the target vehicle z3 is the point x7. The point x2 newly selected for the target vehicle 23 is the same as the point x2 previously selected for the target vehicle z3. The point x2 newly selected for the vehicle z2 (selected at the output step t=8) is the same as the point x2 previously selected for the vehicle z2 (selected at the output step t=5), and the point x6 newly selected for the vehicle z1 (selected at the output step t=7) is the same as the point x6 previously selected for the vehicle z1 (selected at the output step t=4). Therefore, the travel plan generation unit 104 adds the point x6 to the mask information of the vehicle z1, adds the point x2 to the mask information of the vehicle z2, and adds the point x7 to the mask information of the vehicle z3.

The mask information and the route of each vehicle at the time when the processing at the output step t=9 ends are as illustrated in a lower part of FIG. 9. For example, the mask information of the vehicle z1 includes the points x3, x5, x1, x2, x7, and x6, and the route of the vehicle z1 includes the points x1 and x6.

### [Effect]

In the travel plan generation device 100 according to this embodiment, the travel plan generation unit 104 generates the travel plan by performing, at each output step, the processing of selecting any one point out of the plurality of points using the RNN configured to output the visiting probabilities at the plurality of points when the point information regarding the plurality of points and the vehicle information regarding the plurality of vehicles are input thereto, and the mask information indicating the unselectable point. In the mask information of each vehicle, the points already selected for the plurality of vehicles excluding the point previously selected for each vehicle are set as the unselectable points. The processing includes selecting one vehicle out of the plurality of vehicles as the target vehicle according to predetermined order, selecting one point out of the plurality of points excluding the point specified according to the mask information of the target vehicle on the basis of the visiting probabilities at the plurality of points output from the RNN, adding the selected point to the route of the target vehicle, and updating the mask information on the basis of the target vehicle and the selected point. In a case where the point newly selected for the target vehicle is different from the point previously selected for the target vehicle, the travel plan generation unit 104 adds the point previously selected for the target vehicle to the mask information of the target vehicle as the unselectable point, and adds the point newly selected for the target vehicle to the mask information of the plurality of vehicles excluding the target vehicle as the unselectable point. As a result, the previously selected point may be selected again for each vehicle. In other words, it becomes possible not to select an unselected point for each vehicle. It is possible to avoid selecting a point that causes an inefficient route. In many problem cases, it becomes possible to acquire the travel plan closer to an optimal plan.

In a case where the points newly selected for all the vehicles are the same as the previously selected points, the travel plan generation unit 104 adds the point previously selected for each vehicle to the mask information of each vehicle as the unselectable point. As a result, it is possible to avoid a situation in which the processing loops and the travel plan is not generated.

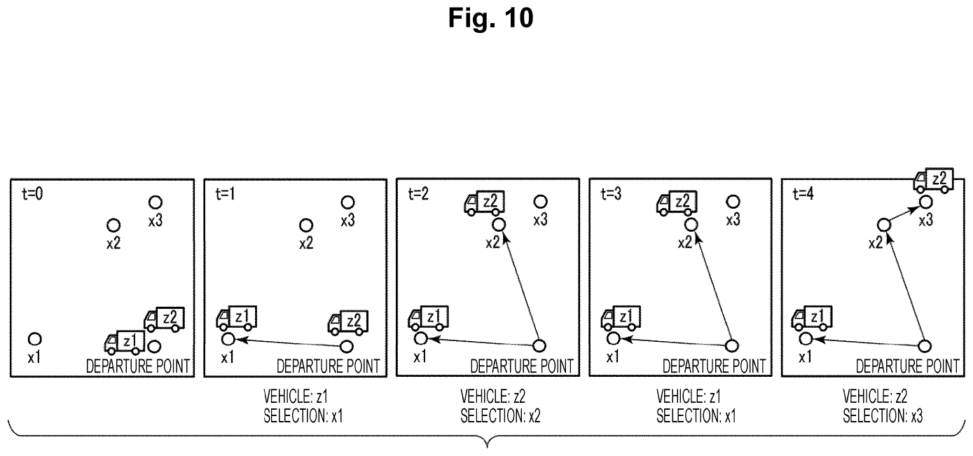

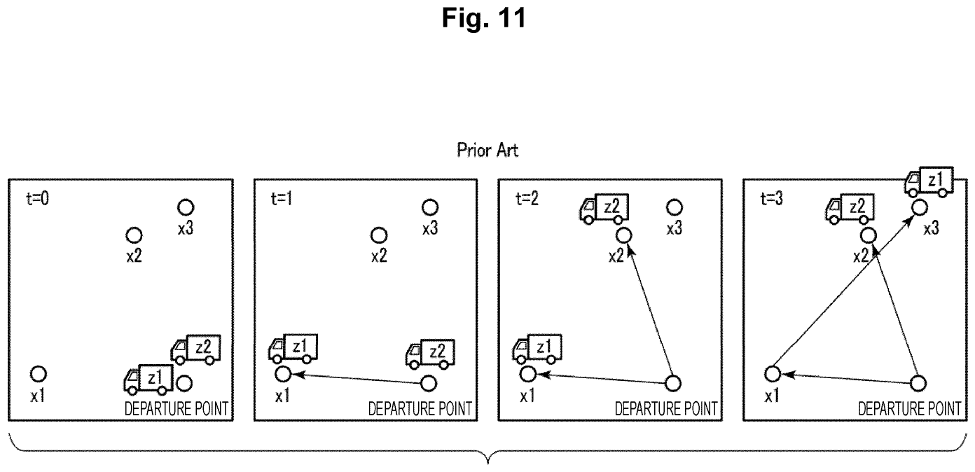

FIG. 10 schematically illustrates travel plan generation processing in the travel plan generation device 100, and FIG. 11 schematically illustrates travel plan generation processing in the technology disclosed in Non Patent Literature 3. In the problem cases illustrated in FIGS. 10 and 11, there are three points x1, x2, and x3, and two vehicles 21 and z2.

Both the travel plan generation device 100 and the technology disclosed in Non Patent Literature 3 generate the travel plan according to a rule of selecting the vehicles in predetermined order. For example, in a case where there are three vehicles z1, z2, and z3, a point to be visited by the vehicle z1 is selected, then a point to be visited by the vehicle z2 is selected, and then a point to be visited by the vehicle z3 is selected. This operation is repeated.

In the technology disclosed in Non Patent Literature 3, as illustrated in FIG. 11, at t=1, vehicle z1 is selected as the target vehicle, and the point x1 is selected as the point to be added to the route of the vehicle z1. At t=2, the vehicle z2 is selected as the target vehicle, and the point x2 is selected as the point to be added to the route of the vehicle z2. At t=3, the vehicle z1 is selected as the target vehicle, and the point x3 is added as the point to be added to the route of the vehicle z1. The total sum of travel distances is smaller when the vehicle z2 visits the point x3 than when the vehicle z1 visits the point x3. Therefore, the acquired travel plan is not an optimal solution.

In contrast, the travel plan generation device 100 may generate the travel plan as illustrated in FIG. 10. Specifically, at t=1, the vehicle z1 is selected as the target vehicle, and the point x1 is selected as the point to be added to the route of the vehicle z1. At t=2, the vehicle z2 is selected as the target vehicle, and the point x2 is selected as the point to be added to the route of the vehicle z2. At t=3, the vehicle z1 is selected as the target vehicle, and the point x1 is selected as the point to be added to the route of the vehicle z1; however, since the point x1 is the same as the previously selected point, this is not added to the route of the vehicle z1. At t=4, the vehicle z2 is selected as the target vehicle, and the point x3 is selected as the point to be added to the route of the vehicle z2. As a result, the travel plan in which the vehicle z1 visits the point x1 and the vehicle z2 visits the points x2 and x3 is generated. The travel plan generation device 100 may acquire the travel plan in which the total sum of the travel distances is smaller. In this manner, this embodiment makes it possible to eliminate selection of the point that causes the inefficient route. Therefore, it is possible to acquire a solution closer to the optimal solution in many cases.

### [Variation]

In the above-described embodiment, the vehicle visits the point. The vehicle is merely an example of a mobile body that visits the point. The mobile body may also be a human.

It is possible that point information does not include information indicating package request amounts at a plurality of points, and vehicle information does not include information indicating loading capacities of a plurality of vehicles. For example, the point information may include only information indicating positions of the plurality of points, and the vehicle information may include only information indicating positions of the plurality of vehicles.

In the embodiment described above, the point newly selected for the target vehicle is set as the unselectable point for the other vehicles (step S805 in FIG. 8). The travel plan generation unit 104 may update the mask information of the other vehicles on the basis of the package capacity at the selected point and the loading capacity of the target vehicle. For example, there is a case where the target vehicle cannot deliver all the packages at the selected point depending on the loading capacity. In this case, any of the other vehicles needs to visit the selected point, and the selected point is not set as the unselectable point for the other vehicles. Specifically, the travel plan generation unit 104 does not update the mask information of the other vehicles in a case where the package request amount at the selected point exceeds the loading capacity of the target vehicle, otherwise this updates the mask information of the other vehicles.

Note that, the present invention is not limited to the embodiment described above and various modifications may be made in the implementation stage without departing from the gist of the invention. The embodiments may be combined appropriately; in this case, combined advantageous effects may be obtained. Furthermore, the embodiment described above includes various inventions, and the various inventions might be extracted by a combination selected from a plurality of disclosed components. For example, in a case where the problem may be solved and the advantageous effects may be obtained despite elimination of some components from all the components described in the embodiment, a configuration from which the components are eliminated may be extracted as the invention.

### REFERENCE SIGNS LIST

100 Travel plan generation device
102 Input unit
104 Travel plan generation unit
106 Travel plan output unit
108 Learning parameter acquisition unit
112 Learning parameter storage unit
202 Encoder
204 Decoder
206 Attention mechanism
501 Processor
502 RAM
503 Program memory
504 Storage device
505 Input/output interface
600 Learning device
602 Input unit
604 Travel plan generation unit
606 Learning unit
608 Learning parameter output unit
612 Learning parameter storage unit

1. A travel plan generation device comprising:
generation circuitry that generates a travel plan for traveling a plurality of points by a plurality of mobile bodies by performing, at each outputting, processing of selecting any one point out of the plurality of points by using a recurrent neural network configured to output visiting probabilities at the plurality of points when point information regarding the plurality of points and mobile body information regarding the plurality of mobile bodies are input, and mask information indicating an unselectable point out of the plurality of points; and
output circuitry that outputs the travel plan,
Wherein points already selected for the plurality of mobile bodies excluding a point previously selected for each mobile body are set as unselectable points in the mask information of each of the plurality of mobile bodies.

2. The travel plan generation device according to claim 1, wherein the processing performed by the generation circuitry further includes:
selecting one mobile body out of the plurality of mobile bodies according to a predetermined order;
selecting one point out of the plurality of points excluding a point specified according to the mask information of the selected mobile body on the basis of the visiting probabilities at the plurality of points output from the recurrent neural network;
adding the selected point to a route of the selected mobile body; and
updating the mask information of the plurality of mobile bodies on the basis of the selected mobile body and the selected point.

3. The travel plan generation device according to claim 2, wherein:
the updating of the mask information of the plurality of mobile bodies includes adding, in a case where a point newly selected for the selected mobile body is different from a point previously selected for the selected mobile body, the point previously selected for the selected mobile body to the mask information of the selected mobile body as the unselectable point.

4. The travel plan generation device according to claim 3, wherein:
the updating of the mask information of the plurality of mobile bodies includes adding, in a case where the point newly selected for the selected mobile body is different from the point previously selected for the selected mobile body, the point newly selected for the selected mobile body to the mask information of the plurality of mobile bodies excluding the selected mobile body as the unselectable point.

5. The travel plan generation device according to claim 2, wherein;
the updating of the mask information of the plurality of mobile bodies includes adding, in a case where the point newly selected for the selected mobile body is the same as the point previously selected for the selected mobile body, and points newly selected for the plurality of mobile bodies excluding the selected mobile body are the same as points previously selected for the plurality of mobile bodies excluding the selected mobile body, a point previously selected for each mobile body to the mask information of the each mobile body as an unselectable point.

6. A travel plan generation method comprising:
generating a travel plan for traveling a plurality of points by a plurality of mobile bodies by performing, at each output step, processing of selecting any one point out of the plurality of points by using a recurrent neural network configured to output visiting probabilities at the plurality of points when point information regarding the plurality of points and mobile body information regarding the plurality of mobile bodies are input, and mask information indicating an unselectable point out of the plurality of points; and
outputting the travel plan,
wherein points already selected for the plurality of mobile bodies excluding a point previously selected for each mobile body are set as unselectable points in the mask information of each of the plurality of mobile bodies body.

7. A non-transitory computer readable medium storing a program for causing a computer to perform the method of claim 6.
